(19) United States
(12) Patent Application Publication
(10) Pub. No.: US 2024/0194360 A1
(43) Pub. Date: Jun. 13, 2024

(54) METHOD AND ASSEMBLY FOR CONTROLLING A NUCLEAR REACTOR, NUCLEAR REACTOR EQUIPPED WITH SUCH AN ASSEMBLY

(71) Applicant: FRAMATOME, COURBEVOIE (FR)

(72) Inventors: Alain GROSSETETE, NANTERRE (FR); Guillaume DUPRE, MALAKOFF (FR); Cyril FIALA, VAUCRESSON (FR); Philippe CHEVREL, CARQUEFOU (FR); Mohamed YAGOUBI, NANTES (FR)

(21) Appl. No.: 18/286,934

(22) PCT Filed: Apr. 14, 2022
(86) PCT No.: PCT/EP2022/060008

§ 371 Date: Oct. 13, 2023

(30) Foreign Application Priority Data
Apr. 14, 2021 (FR) FR2103869

(51) Int. Cl. G21C 7/22; G05B 13/04; G21C 7/36

(52) U.S. Cl. CPC G21C 7/22; G05B 13/041; G21C 7/36

(57) ABSTRACT

A method for controlling a nuclear reactor includes acquiring current values of operating parameters of the reactor; and iteratively implementing the sub-steps of generating a sequence of injection of neutron poison and/or water; calculating an evolution in at least one magnitude characteristic of the state of the core of the nuclear reactor during this given time interval using a power program, current values of operating parameters and the injection sequence considered, the evolution being calculated using a predictive model of the core of the reactor; evaluating a cost function, using the calculated evolution; repeating the generating and calculating sub-steps until a convergence criterion of the cost function is met; and repeating the acquiring and the iteratively implementing steps with a time period less than 60 minutes.

The present disclosure generally concerns the control of nuclear reactors, particularly during power transients.

### BACKGROUND

In recent years, a large number of renewable electricity production facilities have been connected to the electricity grid. As a result, electricity prices can be below zero on the market when solar or wind power generation is significant.

A market price for electricity below zero should prompt nuclear reactor operators to rapidly reduce the electrical power generated by the reactor. On the other hand, a return to high power output is desirable when electricity prices become positive again.

Most of the PWR (Pressurized Water Reactor) type nuclear reactors of the world are operated in what is generally referred to as mode A. These reactors are designed for base load operation, in other words, high, essentially constant electrical power. Power variations are difficult to achieve in reactors operating in mode A and require operators to take precise action to avoid triggering alarms or protections.

As a result, many operators leave their nuclear reactors running constantly in base load, even when electricity prices turn negative.

This situation can be improved by using simulation tools to prepare and verify the feasibility of a power transient. The most advanced simulation tools are online CMS (Core Monitoring System).

These tools are based on 3D neutron codes, which offer excellent accuracy.

However, these tools have the drawback of being slow. Moreover, even if the calculation codes are accurate, the actual trajectory inevitably deviates relative to the theoretical one, due to shortcomings in the models and randomness in the application of commands by operators.

It is also possible to modify nuclear reactors to switch from control mode A to a more flexible control mode, such as G, X, T or ALFC.

However, this change in operating mode is very costly and cannot be implemented quickly. Indeed, this solution requires a complete modification of the control system of the nuclear reactor instrumentation and, in particular, the complete replacement of control algorithms and interfaces with sensors and actuators.

In some cases, this solution also requires the replacement of control clusters.

Furthermore, the operating range of the reactor is modified, so that safety studies have to be repeated, and a new operating license has to be applied for.

A third possibility is to switch from mode A to an RMOSC-type operating method. This method is protected by the patent application filed under number PCT/EP2019/052543, in the name of the applicant.

This method implements a core control means with two cascade controllers, a supervisor using a predictive control algorithm, and a multi-objective controller.

This solution is slightly less costly than switching from mode Ato G, X, T or ALFC mode. The RMOSC can be adapted so as not to alter the operating range of the reactor. However, it remains costly, as it requires significant modification of the instrumentation and control system.

### SUMMARY

Thus, there is a need for a low-cost technical solution that can be implemented rapidly, and which allows to increase the flexibility of nuclear reactors.

In this context, the present disclosure provides, according to a first aspect, a method for controlling a nuclear reactor, the nuclear reactor having a core comprising a plurality of nuclear fuel assemblies, a primary circuit for cooling the core in which circulates a primary heat transfer fluid containing a neutron poison, a unit for injecting neutron poison into the primary heat transfer fluid, and a unit provided for injecting water into the primary circuit, the method comprising the following steps:
S10/ acquiring a reactor power program to be supplied by the nuclear reactor, this program comprising at least one reactor power variation from a first power to a second power;
S20/ acquiring current values of a plurality of operating parameters of the nuclear reactor, comprising at least one parameter characterizing a core power supplied by the core of the reactor and one parameter characterizing the neutron flux distribution in the core;
S30/ iteratively, implementing the following sub-steps:
S31/ generating an injection sequence of neutron poison and/or water into the primary liquid covering a given time interval,
S32/ calculating an evolution of at least one variable characteristic of the state of the core (3) of the nuclear reactor during said given time interval using the acquired power program, the acquired current values of the operating parameters and the injection sequence considered, the evolution being calculated with the aid of a predictive model of the core of the reactor;
S33/ evaluating a cost function, using the calculated evolution;
the sub-steps S31/ to S33/ being repeated until a cost function convergence criterion is met;
S40/ communicating to an operator the optimum injection sequence, in other words, one allowing to meet the convergence criterion, the operator controlling the neutron poison and water injection units as a function of the optimum injection sequence;
the steps S20/ and S30 being repeated with a period less than 60 minutes.

This method allows an optimum sequence for injecting neutron poison and/or water into the primary coolant to be determined quickly, allowing operators to carry out the power transient with confidence.

A key point is that the injection sequence is determined repeatedly, with a period less than 60 minutes, for example of the order of ten minutes.

The injection sequence is therefore updated periodically based on the acquired values of the operating parameters of the reactor, for example every ten minutes.

Only the start of the injection sequence is implemented, before a further recalibration.

This allows to limit the impact of uncertainties on the calculation results provided by the predictive model of the core of the reactor. It also allows to limit drift in the event that the operator does not strictly apply the injection sequence calculated at the previous iteration.

The convergence of a cost function constructed using predictions obtained by simulation of the nuclear reactor allows to determine the best injection sequence and therefore the best trajectory for carrying out the power transient.

This allows the operator to carry out this transient without having to worry about reaching situations leading to the triggering of an alarm or protection of the nuclear reactor.

The control method can also present one or more of the following characteristics, considered individually or in any technically possible combination:
the at least one magnitude characteristic of the state of the core calculated in step S30/ comprises said parameter characterizing the distribution of neutron flux in the core,
the cost function characterizes an evolution of a deviation between said parameter characterizing the neutron flux distribution in the core and a reference value over said given time interval,
the convergence criterion comprises reaching an extremum of the cost function,
the convergence criterion comprises meeting at least one constraint selected from the following list:
a deviation between said parameter characterizing the neutron flux distribution in the core and a reference value during said given time interval remains constantly below a determined limit;
a quantity of neutron poison injected per unit of time during said given time interval remains below a determined limit;
a quantity of water injected per unit of time during said given time interval remains below a determined limit.
in sub-step S31/, the sequence for injecting neutron poison and/or water into the primary liquid is generated by considering the results obtained in the previous iteration, using a gradient descent algorithm,
step S30/ comprises a sub-step S35/ for determining an optimum slope for an evolution of the power as a function of time during the power variation from the first power to the second power, the sub-step S35/ comprising the following operations:
S351/ calculating at least one magnitude characteristic of the state of the core of the nuclear reactor during said power variation with the aid of the predictive model of the core of the reactor, for several values of slope, the injection of neutron poison or water per unit of time being considered constantly equal to the maximum possible;
S352/ evaluating the cost function, using the evolution calculated for each slope value;
S353/ selection of the slope value that minimizes the cost function,
the predictive model of the core of the reactor is non-linear.
the predictive model of the core of the reactor comprises several sub-models, each sub-model modeling a level of the core of the nuclear reactor and comprising at least one equation describing a kinetic of a neutron density at said level and an equation describing a temperature of the primary heat transfer fluid at said level, the model further comprising equations describing neutron exchanges between the levels and equations characterizing a reactivity at each level.
the equations characterizing reactivity at each level take into account one or more of the following effects:
effect due to a variation in the temperature of the primary heat transfer fluid at said level;
effect due to a variation in the power supplied by the core at said level;
effect due to displacement of control rod groups;
effect due to a variation in the concentration of neutron poison in the primary heat transfer fluid;
effect due to variation in xenon concentration in nuclear fuel assemblies at said level.
the sequence for injecting neutron poison and/or water into the primary liquid comprises a plurality of injection operations, each operation being characterized by an operation of quantity and duration, the number of operations in the injection sequence being between 2 and 12, the operation duration being between 2 minutes and 60 minutes.
the period T is less than or substantially equal to the duration of one operation in the injection sequence.
the given time interval has a total duration of between 10 minutes and a power program duration.

According to a second aspect, the present disclosure provides a control assembly for a nuclear reactor, the nuclear reactor having a core comprising a plurality of nuclear fuel assemblies, a primary core cooling circuit in which circulates a primary heat transfer fluid containing a neutron poison, a unit provided for injecting neutron poison into the primary heat transfer fluid, and a unit for injecting water into the primary circuit, the neutron poison and water injection units being controlled by an operator, the control assembly comprising:
a/ a user interface, configured so that a user enters a power program to be supplied by the nuclear reactor, this program comprising at least one power variation from a first power to a second power;
b/ a unit for acquiring current values of a plurality of operating parameters of the nuclear reactor, comprising at least one parameter characterizing the power supplied by the core of the reactor and one parameter characterizing the neutron flux distribution in the core;
c/ a calculation unit including:
   an optimization algorithm, programmed to generate an injection sequence of neutron poison and/or water into the primary heat transfer fluid covering a given time interval,
   a predictive model of the core of the reactor, programmed to calculate an evolution of at least one magnitude characteristic of the state of the core of the nuclear reactor during said given time interval, using the acquired power program, the current values of the acquired operating parameters and the injection sequence considered;
   a cost module configured to calculate a cost function, using the evolution calculated by the predictive model;
the optimization algorithm being programmed to iteratively generate an injection sequence, to calculate the variation of the at least one corresponding magnitude characteristic by the predictive model of the core, to evaluate the corresponding cost function by the cost module, until a cost function convergence criterion is met;
the assembly is also configured to display the optimum injection sequence, in other words, that for which the cost function convergence criterion has been reached, on the user interface, so that the optimum injection sequence is implemented by the operator.

Advantageously, the control assembly is such that the calculation unit comprises a slope module programmed to determine an optimum slope for an evolution of the reactor power as a function of time during the power variation from the first power to the second power, said module being programmed to:
have the predictive model of the core calculate the evolution of at least one magnitude characteristic of the state of the core of the nuclear reactor during said power variation, for several values of slope, the injection of neutron poison or water per unit of time being considered constantly equal to the maximum possible;
have the cost module evaluate the cost functions corresponding to each slope value, using the evolution calculated for each slope value;
select the slope value that minimizes the cost function.

According to a third aspect, the present disclosure provides to a nuclear reactor including a core comprising a plurality of nuclear fuel assemblies, a primary circuit for cooling the core in which circulates a primary heat transfer fluid containing a neutron poison, a unit for injecting neutron poison into the primary heat transfer fluid, a unit provided for injecting water into the primary circuit, and a control assembly having the above characteristics, the neutron poison and water injection units being controlled by an operator.

### BRIEF SUMMARY OF THE DRAWINGS

Further features and advantages of the present disclosure will become apparent from the detailed description given below, by way of indication and by no means limiting, with reference to the appended figures, among which:

FIG. 1 is a schematic representation of a nuclear reactor connected to the electrical distribution network, equipped with the control unit assembly of the present disclosure;

FIG. 2 is a step diagram illustrating the method of the present disclosure;

FIG. 3 is a schematic representation of the predictive model of the core of the reactor used in the method shown in FIG. 2;

FIG. 4 is a schematic representation illustrating the injection sequence and parameter evolution calculated according to the method of the present disclosure;

FIG. 5 is a graphic representation of the evolution of the axial power imbalance (axial offset AO) obtained when the method of the present disclosure is implemented, for a power program including successively a drop in power followed by a rise in power, at the beginning of the cycle;

FIG. 6 is a graphic representation similar to FIG. 5, showing the evolution overtime of the difference between the average temperature of the primary heat transfer fluid in the core Tmoy, and the reference temperature Tref, for the same scenario as FIG. 5;

FIGS. 7 and 8 are graphic representations similar to those in FIGS. 5 and 6, for the same scenario, at the end of the cycle; and

FIG. 9 is a simplified schematic representation of the various modules making up the control assembly fitted to the reactor shown in FIG. 1.

### DETAILED DESCRIPTION

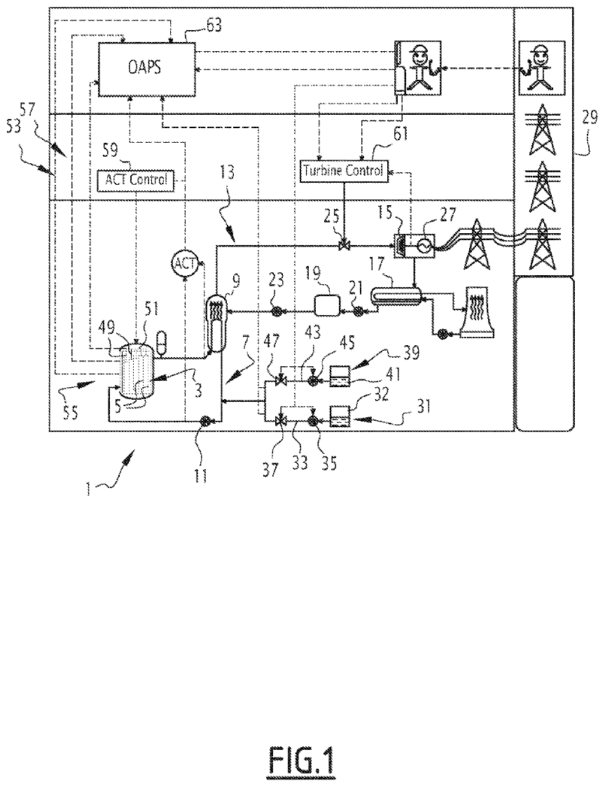

The reactor 1 shown in FIG. 1 includes, in a conventional manner, a core 3, itself comprising a plurality of nuclear fuel assemblies 5.

The nuclear reactor 1 also includes a primary circuit 7, provided to cool the core 3, in which a primary heat transfer fluid containing neutron poison circulates.

Typically, this primary circuit includes several loops, each loop having a steam generator 9 and a primary pump 11.

The nuclear reactor also includes a secondary circuit 13, in which a secondary heat transfer fluid circulates. The secondary heat transfer fluid is vaporized in the steam generator 9, under the effect of the heat released by the primary heat transfer fluid.

The secondary circuit 13 includes at least one turbine 15, a condenser 17, a feed tank 19, and secondary pumps 21, 23.

The secondary heat transfer fluid, in vapor form, flows from the steam generator 9 to the turbine 15, is then condensed in the condenser 17. It is then returned in liquid form to the steam generator 9.

A valve 25 is interposed on the steam line connecting the steam generator 9 to the turbine 15 and allows to regulate the flow of steam fed to the turbine.

The turbine 15 mechanically drives an alternator 27.

The electricity generated by alternator 27 feeds an electrical distribution network 29.

The nuclear reactor 1 also includes a unit 31 allowing the neutron poison to be injected into the primary heat transfer fluid. The neutron poison is typically boron.

A tank 32 containing a concentrated solution of neutron poison, for example boric acid, is connected to the primary circuit 7 by means of the pipe 33. A pump 35 and a valve 37 are interposed on the conduit 33. The unit 31 selectively increases the concentration of neutron poison in the primary liquid.

The nuclear reactor also includes a unit 39 provided to inject water into the primary circuit.

The unit 39 includes a tank 41 connected by a line 43 to the primary circuit 7. A pump 45 and a valve 47 are interposed in the line 43.

The water is typically pure demineralized water.

The unit 39 is provided to inject water into the primary circuit 7, thereby reducing the concentration of neutron poison in the primary heat transfer fluid.

Conventionally, the nuclear reactor 1 also comprises the groups 49 of control rods and a mechanism 51 capable of selectively inserting or extracting the groups 49 of control rods in the core 3 of the nuclear reactor.

The control rods are made of neutron-absorbing material.

The groups of control rods 49 are displaced so as to selectively modify the reactivity inside the core 3.

The nuclear reactor 1 also includes an instrumentation and control system 53.

This instrumentation and control system 53 includes an instrumentation 55 for directly measuring or determining a plurality of operating parameters of the nuclear reactor. These operating parameters comprise at least the following:
power supplied by the turbine 15;
temperature of the primary heat transfer fluid at the inlet and outlet of the core 3;
position of the control rod groups 49;
power supplied by the core 3 of the nuclear reactor;
neutron flux distribution in the core 3.

The instrumentation 55 in particular includes the neutron detectors, located outside the core 3, and distributed over the entire height of the core. These detectors are known as ex-core chambers.

The power supplied by the core is obtained by the calculation, for example, on the basis of information provided by detectors measuring the neutron flux outside the core.

Alternatively, the power supplied by the core is determined by measuring the power supplied by the turbine.

The parameter characterizing the neutron flux distribution in the core is, for example, the axial power distribution, or axial offset AO. The axial offset is calculated using the following formula:

AO=(ϕh−ϕb)/(ϕh+ϕb)

where ϕh is the neutron flux of the upper half of the core, and ϕb the neutron flux of the lower half of the core.

The neutron fluxes of the upper and lower core halves are typically obtained by neutron detectors placed outside the core 3. Alternatively, they are obtained by detectors placed inside the core 3, known as in-core detectors.

Alternatively, the parameter characterizing the neutron flux distribution in the core is ϕh-ϕb, or any other suitable parameter.

Advantageously, the neutron poison flow rate and the water flow rate injected into the primary heat transfer fluid are also measured or determined.

The instrumentation and control assembly 53 also includes a control device 57 configured to regulate a certain number of operating parameters of the nuclear reactor.

The control device 57 comprises at least one loop 59 for controlling the temperature of the primary heat transfer fluid. The loop 59 receives as input the current average temperature Tmoy of the primary heat transfer fluid in the core 3 of the reactor.

This value corresponds, for example, to the average of the temperature measured at the reactor inlet and of the temperature measured at the core outlet.

In the nuclear reactors operating according to mode A, the average temperature of the primary heat transfer fluid Tmoy in the core is controlled by displacing the groups of control rods 49. Four groups of rods, called groups A, B, C, D, can be displaced to control the temperature Tmoy.

The control device 57 also includes a loop 61 for controlling the power supplied by the turbine 15.

The loop 61 receives as input the value of the power supplied by the turbine 15. The loop 61 also receives a turbine power setpoint and a slope setpoint for any variation in the turbine power.

The power and slope setpoints are typically set by the nuclear reactor operator.

The loop 61 controls the valve 25 in the steam line of the secondary circuit 13, as a function of the power and slope setpoints, and as a function of the current turbine power value.

Furthermore, the operator directly controls the neutron poison and water injection units 31 and 39.

The operator sets the quantity of neutron poison injected per unit of time into the primary heat transfer fluid, and the quantity of water injected per unit of time into the primary heat transfer fluid. Typically, they set the volume flow rate of the neutron poison solution injected, and the volume flow rate of the water injected.

The present disclosure is particularly suited to cases where the nuclear reactor has to follow a power program comprising at least one power variation, also called transient, from a first power to a second power.

This is particularly the case when the nuclear reactor 1 has to operate in load-following mode.

Typically, the power schedule in this case is supplied to the nuclear power plant operator by the person responsible for managing the electricity transmission network 29.

In nuclear reactors operating according to mode A, the average temperature of the primary heat transfer fluid Tmoy in the core is controlled by displacing the groups of control rods 49.

When the nuclear reactor is operating in load-following mode, only the group D is displaced by the loop 59, to avoid excessive disruption of neutron flux distribution in the core.

Variations in the power level delivered by the nuclear reactor are achieved by adjusting the concentration of neutron poison in the primary heat transfer fluid. This is done by injecting neutron poison or water into the primary circuit 7, using units 31 and 39.

Such control of the output power of the nuclear reactor by adjusting the neutron poison concentration becomes slower and slower as the nuclear fuel is depleted. Theoretically, the maximum slope of load variation is 1.5% of rated power per minute at the start of the cycle, and 0.10% of rated power per minute at 90% of the cycle. Furthermore, these power adjustments are tricky to achieve, as they require very precise control of the quantities of neutron poison injected into the primary circuit.

By comparison, the maximum possible slope in mode G or in mode T is 5% of rated power per minute up to 80% of the cycle.

The present disclosure aims to overcome these difficulties by adding a control unit 63 to the nuclear reactor, which will provide the operator with a neutron poison and/or water injection sequence in the primary liquid, specially adapted to the power program to be delivered. Optionally, the control unit 63 also provides a recommended slope for the or each power variation to be carried out during the power program.

The control unit 63 is provided to implement the nuclear reactor control method which will now be described.

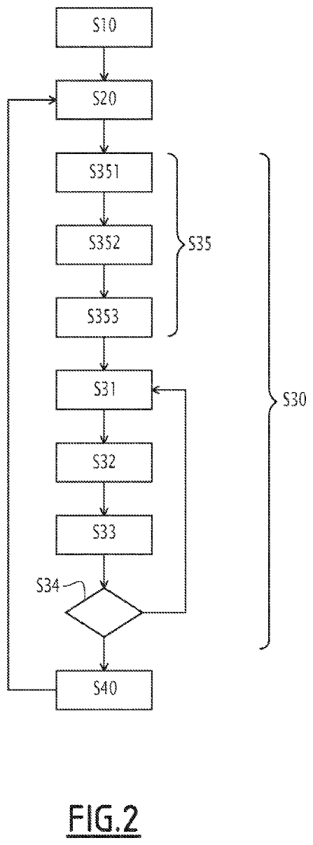

The control method as shown in FIG. 2 comprises a step S10 for acquiring a reactor power program to be supplied by the nuclear reactor. This program includes at least one reactor power variation from a first power to a second power.

The reactor power typically corresponds to the mechanical power supplied by the turbine.

The variation in reactor power is typically of non-zero amplitude.

In other words, the control method is particularly suited to the case of a nuclear reactor following a power program having a power transient.

This is the case when the nuclear reactor is operating in load-following mode, as described above.

The power program to be followed is, in this case, typically provided by the electricity distribution network operator 29, as described above.

The control method is also suitable for reactors not operating in load-following mode, but which have to manage significant power transients.

The variation in reactor power is typically several tens of percent of the rated power of the reactor.

However, the control method can also be applied to small amplitude power variations, for example when the reactor is operating in remote control mode. In this case, the power variations are a few percent of the rated power of the reactor, for example less than 10%, or even less than 5%.

The control method also applies to the case where the nuclear reactor is operating in base mode. The power variations are therefore zero, the first power being equal to the second power.

In this case, the nuclear reactor operates at constant power, typically at 100% of its rated power level (RPL). Fuel depletion in such a case leads to a drop in the average temperature of the primary heat transfer fluid, which causes a change in the cost function. The control method then proposes neutron poison or water injection recommendations to restore an optimal situation.

Typically, the reactor power program covers a twenty-four hour period. It includes a single reactor power variation, or alternatively it may include several.

For example, the reactor power program is a (time) window, initially including a power reduction, followed a few hours later by a return to the initial power level.

The control method also includes a step S20 for acquiring the current values of a plurality of operating parameters of the nuclear reactor 1.

The operating parameters comprise at least one parameter P characterizing a core power supplied by the core 3 of the nuclear reactor, and a parameter R characterizing the neutron flux distribution in the core 3.

Preferably, one or more of the following operating parameters are also acquired in step S20:
average temperature Tmoy of the primary heat transfer fluid in the core 3 of the nuclear reactor;
position of the groups control units 49, Pbank;
quantity of neutron poison injected into the primary heat transfer fluid per unit time Qpn;
quantity of demineralized water injected into the primary heat transfer fluid per unit time Qw.

These operating parameters are retrieved directly from the instrumentation and control system 53 of the nuclear reactor or are calculated from values retrieved from this system 53.

The parameter characterizing the core power P supplied by the core of the reactor is, for example, the thermal power supplied by the core.

This parameter is reconstructed by the system 53 using neutron flux measurements from the neutron detectors located outside the core.

Alternatively, this parameter can be reconstituted from measurements of the power supplied by the turbine, or of the temperatures of the primary heat transfer fluid, at the inlet and outlet, Tin and Tout, of the core.

Alternatively, the parameter characterizing core power is the total neutron flux in the core, or the power supplied by the turbine, or any other suitable parameter.

The parameter R characterizing the neutron flux distribution in the core is typically the axial offset AO. It is typically reconstituted, as described above, from measurements provided by the detectors measuring neutron flux outside or inside the core. Alternatively, this parameter is the difference between the neutron flux in the upper part of the core and the neutron flux in the lower part of the core.

The average temperature Tmoy of the primary heat transfer fluid is calculated using the temperature measurement of the primary heat transfer fluid at the core outlet Tout and the measurement of the primary heat transfer fluid at the core inlet Tin. For example, Tmoy is calculated using the following equation:

Tmoy=(Tin+Tout)/2

The quantity of neutron poison injected per unit time Qpn is determined using a flow sensor installed in the pipe 33. Alternatively, it can be determined using the speed of rotation of the pump rotor 35 or any other suitable magnitude.

Similarly, the quantity of water injected per unit of time Qw is determined using the measurement provided by a flow sensor installed in pipe 43. Alternatively, it is reconstituted using the speed of rotation of the pump rotor 55, or any other suitable magnitude.

The method also includes a step S30 for determining the optimum neutron poison and/or water injection sequence, for a given time interval, taking into account the reactor power program to be carried out.

The step S30 includes several sub-steps, which are implemented iteratively.

The step S30 includes a sub-step S31 for generating a neutron poison and/or water injection sequence into the primary liquid, covering a given time interval.

The neutron poison and/or water injection sequence comprises a plurality of injection operations, each operation being characterized by a quantity of neutron poison or water injected, and a duration of the operation.

The number of operations in the injection sequence is between two and twelve, preferably between three and eight, and is, for example, six.

The duration of the operation is between two and sixty minutes, preferably between five and twenty minutes, and is, for example, ten minutes.

The given time interval has a total duration of between ten minutes and the duration of the power program, preferably between twenty minutes and three hours, even more preferably between thirty minutes and two hours, and is worth, for example, one hour. The given time interval covers a portion of the reactor power program.

The quantity injected at each operation is expressed in volume or mass or corresponds to a flow rate of neutron poison solution or water.

The injection operations are successive operations, immediately following each other, covering the entire time interval. Within the same injection sequence, there are only neutron poison injection operations, or only water injection operations, or operations of a different nature: neutron poison injection, water injection, no injection.

The step S30 also includes a sub-step S32 for calculating an evolution in at least one magnitude characteristic of the state of the core of the nuclear reactor during said given time interval.

The at least one magnitude characteristic of the calculated state of the core depends, among other things, on the chosen cost function, which will be described below.

The at least one magnitude characteristic comprises at least the parameter R characterizing the neutron flux distribution in the core, for example, the axial offset AO.

The at least one magnitude characteristic of the state of the core preferably comprises one or more of the following magnitudes:
power P supplied by the core;
average temperature Tmoy of the primary heat transfer fluid in the core;
position of the Pbank control rod groups.

Typically, all the above magnitudes are calculated.

This calculation is carried out with the aid of a predictive model of the core of the reactor, using the acquired power program, the acquired current values of the operating parameters, and the injection sequence generated in sub-step S31.

More specifically, the sub-step S32 uses the portion of the power program covered by the given time interval.

The predictive model of the core of the reactor is a non-linear model. Alternatively, the model is linear. This model is then obtained, for example, by linearizing the non-linear model described below.

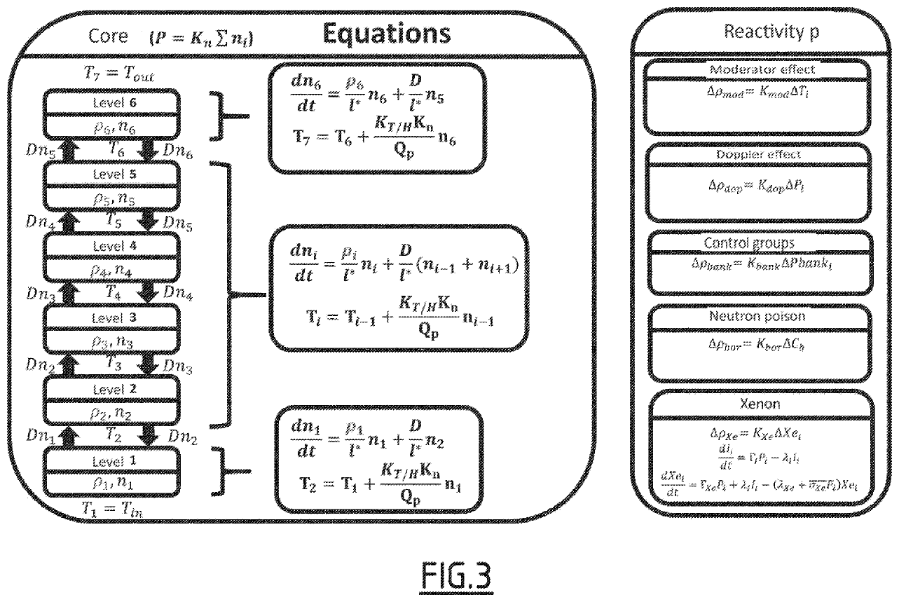

This model is illustrated schematically in FIG. 3.

The predictive model of the core comprises several sub-models, each sub-model modeling a level of the core 3.

In other words, the core is divided vertically into several slices, each sub-model modeling one of the core slices.

Typically, the predictive model of the core comprises between two and twenty sub-models, preferably between two and ten sub-models, and includes, for example, six sub-models.

Each sub-model comprises at least one equation describing a neutron density kinetic in said level, and one equation describing a temperature of the primary heat transfer fluid at said level.

The temperatures T2 to T7 at the outlet of each level are deduced from the neutron flux in each level.

The equations are shown below:

$$Level 1 :$$

$${T}_{2} = {T}_{1} + \frac{{K}_{T / H} {K}_{n}}{{Q}_{p}} {n}_{1}$$

$$\frac{d {n}_{1}}{d t} = \frac{{ρ}_{1}}{{l}^{*}} {n}_{1} + \frac{D}{{l}^{*}} {n}_{2}$$

$$Level i :$$

$${T}_{i} = {T}_{i - 1} + \frac{{K}_{T / H} {K}_{n}}{{Q}_{p}} {n}_{i - 1}$$

$$\frac{d {n}_{i}}{d t} = \frac{{ρ}_{i}}{{l}^{*}} {n}_{i} + \frac{D}{{l}^{*}} ( {n}_{i - 1} + {n}_{i + 1} )$$

$$Highest level :$$

$${T}_{7} = {T}_{6} + \frac{{K}_{T / H} {K}_{n}}{{Q}_{p}} {n}_{6}$$

$$\frac{{dn}_{6}}{dt} = \frac{{ρ}_{6}}{{l}^{*}} {n}_{6} + \frac{D}{{l}^{*}} {n}_{5}$$

with:
nᵢ: neutron density at level i;
pᵢ: reactivity at level i
D: neutron exchange coefficient;
I*: average neutron lifetime (prompt and delayed);
K_{T/H}H: temperature/enthalpy conversion coefficient;
Kn: power/neutron flux conversion coefficient;
Qp: primary heat transfer fluid mass flow rate in the core.
T1: core inlet temperature;
Ti: temperature of the primary heat transfer fluid at the outlet of each level;

Thus, each core level is modeled using a one-group approximation of a group of neutron point kinetics, with the addition of a D coefficient to account for neutron exchanges between levels.

Delayed neutrons and precursors, the dynamics of which exceed those expected by the method or operator, are not modeled. These neutrons have a typical dynamic of 10 seconds, for a calculation time step of the order of 60 seconds.

Furthermore, the model includes equations characterizing the reactivity at each level.

These equations take into account one or more of the following effects:
effect due to a variation in the temperature of the primary heat transfer fluid at said level (also known as the moderating effect);
effect due to a variation in the power supplied by the core at said level (Doppler effect);
effect due to displacement of the groups of control rod;
effect due to variation in neutron poison concentration in the primary heat transfer fluid;
effect due to a variation in xenon concentration in the nuclear fuel assemblies at said level.

The equations are as follows:

$${ρ}_{i} = {ρ}_{i 0} + Δ {ρ}_{m o d} + Δ {ρ}_{d o p} + Δ {ρ}_{b a n k} + Δ {ρ}_{b o r} + Δ {ρ}_{x e n o n}$$

$$with {Δρ}_{m o d} = {K}_{m o d} Δ {T}_{i}$$

$$Δ {ρ}_{d o p} = {K}_{d o p} Δ {P}_{i}$$

$$Δ {ρ}_{b a n k} = {K}_{b a n k} Δ P b a n {k}_{i}$$

$$Δ {ρ}_{b o r} = {K}_{b o r} Δ Cpn$$

$$Δ {ρ}_{x e n o n} = {K}_{x e n o n} Δ X {e}_{i}$$

$$\frac{{dI}_{i}}{d t} = {Γ}_{I} {P}_{i} - {λ}_{I} {I}_{i}$$

$$\frac{d X {e}_{i}}{d t} = {Γ}_{X e} {P}_{i} + {λ}_{I} {I}_{i} - ( {λ}_{X e} + \overline{{σ}_{X e}} {P}_{i} ) X {e}_{i}$$

where
pᵢₒ: initial reactivity at level i, determined at the moment when the initial state of the predictive model of the core is adjusted on the basis of the current values of the operating parameters acquired (see below);
Pᵢ: thermal power supplied by level i of the core, assumed proportional to neutron density;
Xeᵢ: xenon concentration in nuclear fuel assemblies at level i;
Ii: iodine concentration at level i;
Γ_{I}: fission iodine production coefficient;
λ_{I}: iodine decay constant in xenon;
Γ_{Xe}: coefficient of xenon production by fission;
λ_{Xe}: xenon decay constant;
σ̅_̅{̅X̅e̅}̅: neutron absorption transmutation coefficient of xenon 135 to xenon 136.

In the above equations, A notes a variation relative to the initial state of the predictive model.

The effect due to the variation in the power supplied by the core allows us to characterize the effect of a variation in nuclear fuel temperature, also known as the Doppler effect.

The evolution of the xenon 135 at each level is modeled using conventional equations that take into account:
the production of iodine by fission;
radioactive decay of iodine to xenon;
xenon production by fission;
radioactive decay of xenon;
transmutation of the xenon 135 to xenon 136 by neutron absorption.

ΔPbankᵢ corresponds to the displacement of all the control groups within level i, expressed in steps. This parameter corresponds to the sum of the variations in the number of insertion steps in level i of all the control groups.

ΔPᵢ is obtained by the following equation:

ΔPᵢ=Kn×Δnᵢ, where Kn is a predetermined constant.

Furthermore, the model integrates the following general equation:

P=KₙΣnᵢ

P being the total power supplied by the core.

The evolution of the total power supplied by the core is imposed by the power program, taking into account the slope retained for power variations as described below.

The coefficients K_{T/H}, Kₙ K_{mod}, K_{dop}, K_{bor}, K_{bank}, Kₓₑₙₒₙ, D, the iodine and xenon evolution coefficients Γ_{I}, Γₓₑ and σ̅_̅{̅X̅e̅}̅, have been determined by numerical simulations. Some can also be determined by on-site measurements. The coefficients I*, λI, λXe are known values. Alternatively, I* is determined by calculation.

The value of ΔPbankᵢ is determined by the model, as a function of the evolution of the average temperature Tmoy of the primary heat transfer fluid in the core. This module first determines the value of Tmoy according to the following equation:

Tmoy=(T1+T7)/2

Then, the model determines an average reference temperature Tref, as a function of the reactor power supplied by the power program and the slope selected for the transients.

The model then determines the difference ΔTmoy between Tmoy and the mean reference temperature Tref.

If Tmoy falls outside the temperature dead zone, in other words if ΔTmoy exceeds a predetermined threshold value, the model sets the value of Tmoy at the dead zone limit and determines that it is necessary to displace the control units. It calculates a value for ΔPbank as a function of ΔTmoy, allowing criticality to be achieved.

The reference temperature values and the temperature dead zone width as a function of reactor power are predetermined values stored in the model or are supplied by the instrumentation and control system 53.

This model thus simulates the operation of the temperature loop 59.

ΔCpn is obtained by integrating the quantities of neutron poison and/or water injected into the primary heat transfer fluid. The model uses the following equations:

dCpn/dt=−Cpn×Qw/Mt for water injection;

dCpn/dt=(Crea−Cpn)×Qpn/Mt for neutron poison injection,

with Mt total mass of water in the primary circuit, for example, 260 tons for an N4 level, Crea concentration of neutron poison in the neutron poison solution injected, Cpn current concentration of neutron poison in the primary heat transfer fluid, Qw flow rate of demineralized water injected, Qpn flow rate of neutron poison solution injected.

A delay is considered to evaluate the effect of demineralized water or neutron poison injection.

The value of Qp, in other words, the primary heat transfer fluid flow rate in the core, is a predetermined value.

Alternatively, it is retrieved from the instrumentation and control system 53 at acquisition step S20.

Before the first iteration of step S30, in other words, immediately after step of acquiring the current values of the operating parameters, the initial state of the predictive model of the core is adjusted using the acquired current values of the operating parameters.

For example, the values of the power P emitted by the core, and Tmoy are used to set T1 to T7. The values of the power P emitted by the core and axial offset are used to determine the values of n₁ to n₆. The position value of the control groups is used to directly set the starting value of Pbank.

The equations are balanced in the model by adjusting the various reactivity terms, so that the time evolution of neutron densities is zero.

After this initial adjustment, the predictive model of the core calculates for each level of the core the evolution in time, over the given time interval, of the neutron concentration nᵢ, the temperature Tᵢ and the xenon concentration Xₑᵢ.

From these parameters, the model reconstructs the evolution of more global parameters such as the mean temperature Tmoy, and the parameter R characterizing the neutron distribution in the core, for example the axial offset AO.

The model also determines the evolution of the position of the Pbank groups and the neutron poison concentration Cpn, as described above.

The evolution of the power P emitted by the core follows the power program during the given time interval, taking into account the slope chosen for the power variations.

The step S30 also includes a sub-step S33 for evaluating a cost function, using the evolution of the magnitude characteristics determined in the sub-step S32.

For example, the cost function characterizes an evolution of a deviation δR between the parameter characterizing the distribution R of the neutron flux in the core, typically the axial offset, and a reference value Rref, over said given time interval.

Rref is a predetermined value, dependent on reactor power.

The reference value Rref is entered manually by the operator. Alternatively, it can be retrieved from the instrumentation and control system 53. Indeed, this system comprises a reference curve giving the reference value directly as a function of the current reactor power.

To calculate the cost function, Rref is taken as constant over the given time interval, or as variable depending on the power program.

Thus, the cost function is chosen to minimize deviations between the parameter R characterizing the distribution of neutron flux in the core and the reference value.

The cost function is, for example, as follows,

f(R)=∫ₜ₀^{t0+Tpredic}(δR)²dt

with

δR=R−Rref, where t0 is the start of the time interval and Tpredict the duration of the time interval.

Another example of a cost function is given below:

f(Rcor)=∫ₜ₀^{t0+Tpredic}(δRcor)²dt

where

Rcor=R+K(Tmoy−Tref), K being a constant,

and δRcor=Rcor−Rref

Different values can be assigned to the constant K according to whether it is at the start of the cycle for assemblies loaded into the core of the reactor, or at the end of the cycle. For example, if the parameter characterizing neutron flux distribution in the core is the axial offset AO, the value chosen for K is −2% AO/° C. at the start of the cycle, and −6% AO/° C. at 80% of the cycle.

The advantage of this second function is that it allows the optimum injection sequence to be determined even when Tmoy remains within its dead zone. Indeed, in this case, the groups of control rods are not displaced, and the value of the R parameter characterizing the neutron flux distribution in the core remains unchanged. The first cost function considered, in such a situation, is constant whatever the values of Qp, and Q, injected. The second cost function, on the other hand, varies and allows to discriminate the different injection sequences under consideration.

The second function allows, therefore, to take into account variations in the parameter R characterizing the distribution of neutron flux in the core, induced by the variations in Tmoy in its dead zone.

The step S30 then includes a sub-step S34 to determine whether a convergence criterion for the cost function has been met.

As shown in FIG. 2, if this convergence criterion is not met, the sub-steps S31, S32 and S33 are repeated, with a new neutron poison and/or water injection sequence.

In step S31, the neutron poison and/or water injection sequence into the primary liquid is generated for the new iteration by considering the results obtained in the previous iteration.

Preferably, the injection sequence for the new iteration is generated using a gradient descent algorithm, typically with an optimization method known as the primal dual interior point method.

This method is well known and will not be detailed here.

On the contrary, if the convergence criterion is met, step S40 is carried out. During step S40, the optimum injection sequence, in other words, the one allowing the convergence criterion to be achieved, is communicated to the operator.

The evolution of the magnitude characteristic of the state of the core corresponding to this optimum injection sequence, is also communicated to the operator.

For example, the injection sequence and the evolution of the magnitude characteristic of the state of the core during the given time interval are displayed on a user interface screen, as shown in FIG. 3.

The convergence criterion comprises at least the fact that the cost function reaches an extremum.

In the above examples, this extremum is a minimum.

In other words, the deviation between the parameter R characterizing the neutron flux distribution in the core and the reference value must be a minimum over said given time interval.

In addition, the convergence criterion can stipulate that one or more of the following constraints are met:
the deviation between the parameter R characterizing the neutron flux distribution in the core and the reference value during said given time interval remains constantly below a determined limit;
a quantity of neutron poison injected per unit of time during said given time interval remains below a determined limit;
a quantity of water injected per unit of time during said given time interval remains below a determined limit.

The first constraint reflects the fact that the parameter R characterizing the neutron flux distribution in the core, typically the axial offset AO, must not exceed limits around its reference value Rref during the given time interval.

This criterion can be expressed by the following equation:

|R−Rref|<L

where L is the limit not to be exceeded.

The limit is defined by the normal operating conditions of the nuclear reactor.

The limit imposed on the quantity of neutron poison injected per unit time typically corresponds to the maximum volume flow rate that can be delivered by unit 31.

The limit imposed on the quantity of water injected per unit of time similarly corresponds to the maximum volume flow rate that can be delivered by unit 39.

These limits are a function of the maximum possible flow rate for pumps 35 and 45.

According to the method, steps S20 and S30 are repeated with a time period T less than sixty minutes, preferably less than twenty minutes, for example ten minutes.

In other words, the method allows the operator to be provided with an optimum injection sequence, repeatedly for a short period. This injection sequence is recalibrated to the current values of the reactor operating parameters.

The period T is less than or equal to the duration of one operation of the injection sequence.

The period T is a parameter that can be adjusted by the nuclear reactor operator.

The minimum value of T corresponds to the time required to execute steps S20 and S30.

Typically, the period T is substantially equal to the duration of one operation in the injection sequence.

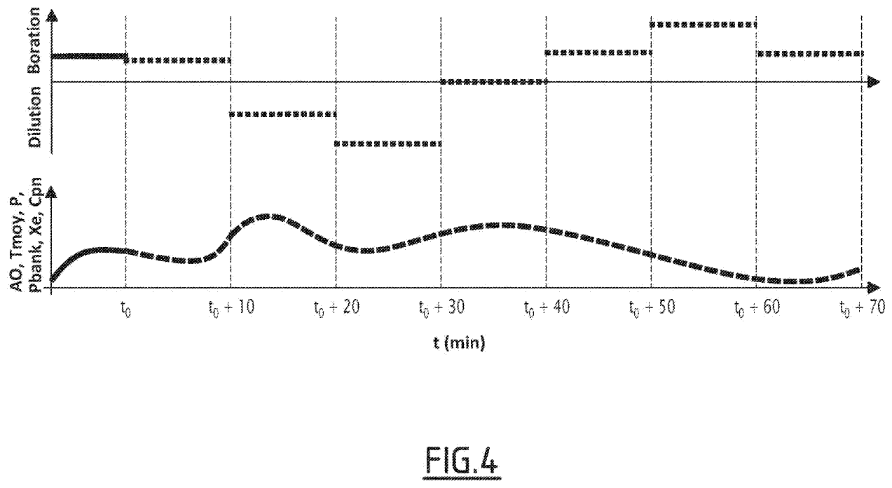

Thus, as illustrated in FIG. 4, the operator starts executing steps S20 and S30 at time t0. Between t0 and t0+T, the setpoint determined at the previous iteration is implemented for the first operation of the optimum injection sequence.

The operator receives the result of the recalculation, in other words, the new optimum injection sequence, toward the end of the current injection operation, in other words, just before t0+T. Between t0+T and t0+2T, the recommendations received for the first operation of the new optimum injection sequence are implemented, and so on.

Alternatively, the period T is less than the duration of one operation of the injection sequence.

Here DI is the duration of an injection sequence operation.

This alternative is chosen when the calculation time for executing steps S20 and S30 is short. The calculation time may be less than 1 minute.

In this case, between t0 and t0+DI, the operator implements the setpoint determined at the previous iteration (between t0-DI and t0) for the first operation of the optimum injection sequence.

At t0, the operator initiates steps S20 and S30. These steps are repeated several times between t0 and t0+DI. The operator retains the result of the last calculation, in other words, the optimum injection sequence received toward the end of the current injection operation, just before t0+DI. Between t0+DI and t0+2DI, the recommendations received for the first operation of the new optimum injection sequence are implemented, and so on.

Advantageously, step S30 comprises a sub-step S35 for determining an optimum slope for the evolution of power as a function of time, during the power variation from the first power to the second power.

This sub-step S35 is carried out immediately before sub-step S31, as illustrated in FIG. 4.

The optimum slope to be determined is the maximum feasible slope without the operator running the risk of triggering an alarm or protection of the nuclear reactor.

The sub-step S35 comprises the following operations:
S351: calculating an evolution of at least one magnitude characteristic of the state of the core of the nuclear reactor during said power variation, with the aid of the predictive model of the core of the reactor, for several values of slope, the injection of neutron poison or water per unit of time being considered to be constantly equal to the maximum possible;
S352: evaluating the cost function, using the evolution calculated for each slope value considered;
S353: choosing the slope value that minimizes or maximizes the cost function.

The slope values tested are the typical slope values for a nuclear reactor in the circumstances considered. These slope values are well known. They vary, for example, between 0.5 and 10%, typically between 0.1 and 5%, depending on the situation.

The slope values are constant throughout the duration of the power variation.

Alternatively, the slope values are variable during the transient. For example, different slope values can be chosen for different portions of the transient. Thus, one slope value may be chosen for the 80% RPL-90% RPL portion, another for the 90% RPL-100% RPL portion, etc.

The operation S351 is carried out with the predictive model of the core already recalibrated using the current values acquired in step S20. The calculation horizon here corresponds to the entire time required to pass from the first power to the second power, taking into account the slope considered.

The cost function used for operation S352 is the one described above.

The slope value considered as optimum is that for which the cost function is minimum or maximum, depending on the cost function chosen.

For the cost functions described above, the slope value considered optimum is that which minimizes the cost function.

For operation S353, it is possible, as an alternative, to consider that the optimum slope value is that which not only minimizes or maximizes the cost function, but also respects one or more operational constraints. These operational constraints are those listed above.

The slope value selected for the power variation is communicated to the operator at step S40. For example, the slope value selected corresponds to the optimum slope determined minus a safety coefficient. The safety coefficient is, for example, 30%.

During each iteration of step S32, the evolution of core power considered to carry out the simulations is determined using the slope value selected, determined in sub-step S35.

This slope is considered constant throughout the power transient. It is only modified if a new power program is proposed by the operator. Alternatively, as indicated above, the slope is variable during the transient.

Alternatively, sub-step S35 is not implemented. In this case, the operator sets the slope at which the power transient from the first power to the second power is carried out. It is this value that will be considered for each iteration of sub-step S32.

An optimum slope is determined or set for each reactor power variation in the power program.

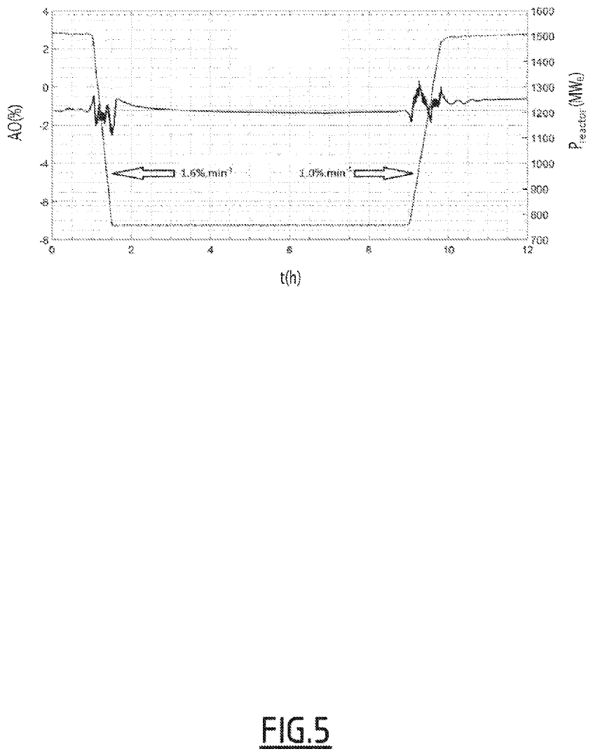

FIGS. 5 to 8 illustrate the results obtained by implementing the control method of the present disclosure.

These results were obtained by simulation using the SOFIA simulator (Simulator for Observation of Functioning during Incident and Accident). This software, developed by Framatome, simulates in detail all the main components of a PWR-type nuclear reactor, as well as the main phenomena involved during normal reactor operation (core kinetics, primary and secondary circuit thermal-hydraulics, instrumentation, control system, turbine drive system, etc.).

In the simulation, it is assumed that the injection sequences determined according to the method of the present disclosure are immediately applied, without modification, to the nuclear reactor. Two simulations have been carried out.

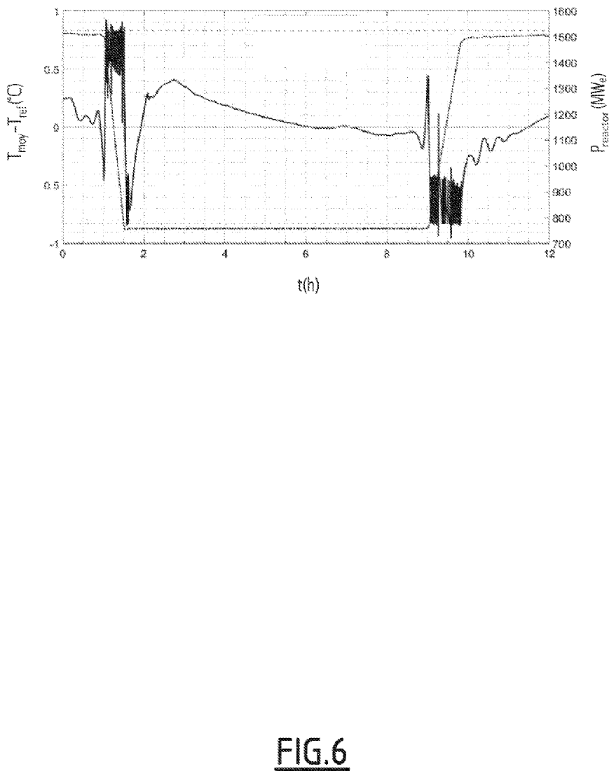

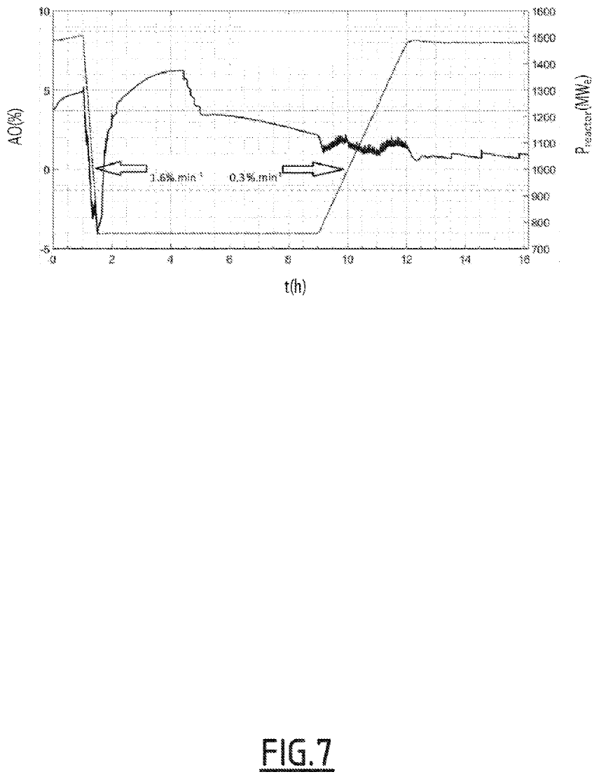

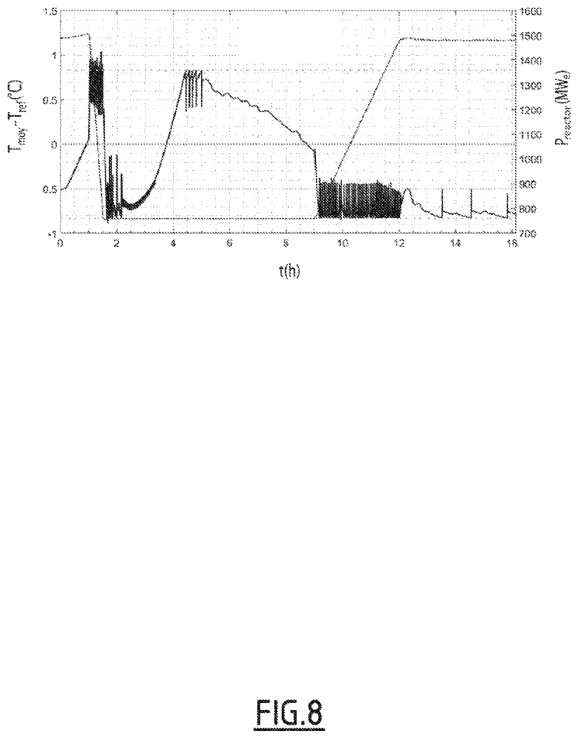

In FIGS. 5 and 6, the core is loaded with fresh fuel assemblies, with a substantially zero burnup rate and a boron concentration of around 1200 ppm in the primary heat transfer fluid. In FIGS. 7 and 8, the simulation is carried out for a core at 80% of its cycle, and a boron concentration of around 200 ppm.

The power program considered is illustrated in FIG. 5 and FIG. 7. The nuclear reactor operates in load-following mode, following a conventional cycle in which reactor power is first decreased from 100% of rated power to 50% of rated power, then increased again to 100% of rated power. There is an eight-hour gap between the start of the load reduction and the start of the load increase.

In the case of FIGS. 5 and 6, the present disclosure method indicates that a slope of 1.6% of rated power per minute is used for load reduction, and 1% of rated power per minute for load increase.

These values correspond to 70% of the optimum slope determined by step S35, rounded to a value accepted by SOFIA. SOFIA only accepts discrete slope values. The situation is the same on site, where only certain slope values can be applied.

FIG. 5 shows the evolution of the axial offset in the core of the reactor when the optimum injection sequences are applied. FIG. 6 shows the deviation between Tmoy and Tref when the optimum injection sequences are applied.

FIG. 5 also shows the axial offset reference value (horizontal line in the center of the figure), as well as the limits of the axial offset dead zone (dashed horizontal line at the top and bottom of FIG. 5). In this non-limiting example, the limits have been set at 5%.

It is clear from FIG. 5 that, even during power transients, the axial offset does not deviate significantly from its reference value and remains far from the dead zone limits.

In FIG. 6, the Tmoy temperature dead zone limits are shown as dashed lines at the top and bottom of the figure. FIG. 6 clearly shows that Tmoy remains within its dead zone, and only leaves it occasionally, during power transients, as a result of temperature control.

FIGS. 7 and 8 are similar to FIGS. 5 and 6. The slopes selected according to the present disclosure method are 1.6% of rated power per minute for load reduction, and 0.3% of rated power per minute for load increase.

FIG. 7 shows that the axial offset occasionally leaves its dead zone at the end of the load reduction. However, this does not call into question the feasibility of this load transient, as this exit from the dead zone is short-lived. Tmoy also leaves its dead zone occasionally, particularly at the moment when the load reduces.

The control assembly 63, which will now be described in detail is particularly suitable for implementing the control method described above.

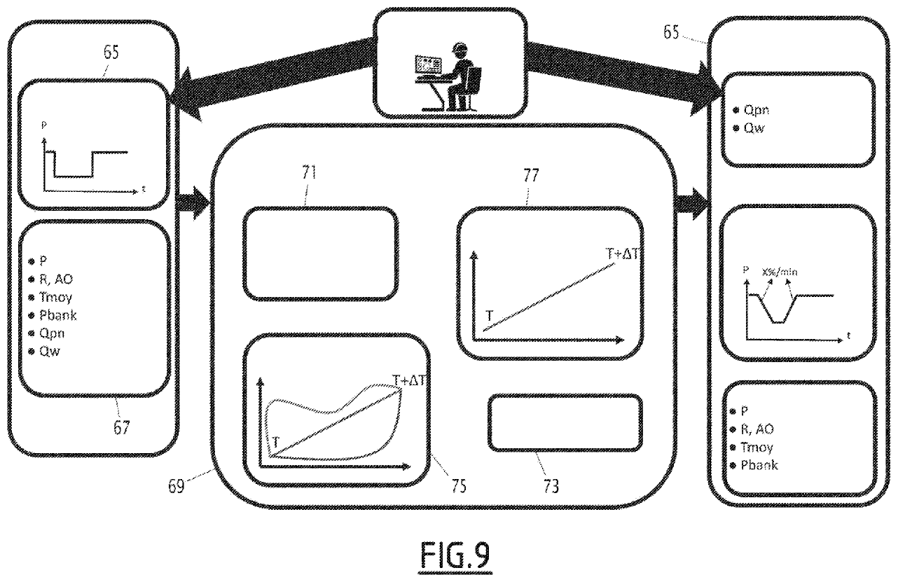

As shown in FIG. 9, the control assembly 63 comprises a user interface 65, configured so that an operator can enter the power program to be supplied by the nuclear reactor.

The power program comprises at least one power variation from a first power to a second power.

The power program is as described above for the control method.

The user interface 65 is of any suitable type. For example, it comprises a keyboard and a screen, connected to a computer.

The assembly 63 also includes a unit 67 for acquiring current values of a plurality of nuclear reactor operating parameters.

This unit 67 is a computer, or part of a computer.

Typically, the acquisition unit 67 retrieves the current values of the operating parameters from the instrumentation and control system 53.

The plurality of nuclear reactor operating parameters comprises at least one parameter characterizing the power P supplied by the core of the reactor, and a parameter R characterizing the neutron fluid distribution in the core.

The operating parameters acquired by unit 67 are those described above for the control method.

The control unit 63 also includes a calculation unit 69.

The calculation unit 69 includes a predictive model 71 of the core of the reactor, a module 73 configured to calculate a cost function, and an optimization algorithm 75.

The unit 67, for example, is integrated into the calculator 69.

The optimization algorithm 75 is programmed to generate an injection sequence of neutron poison and/or water into the primary liquid covering a given time interval. The sequence for injecting neutron poison and/or water into the primary liquid comprises a plurality of injection operations, each operation being characterized by an operation quantity and duration.

The injection sequence is as described above for the control method.

The predictive model 71 of the core of the reactor is programmed to calculate an evolution of at least one magnitude characteristic of the state of the core of the nuclear reactor during the given time interval, using the acquired power program, the acquired current values of the operating parameters and the injection sequence considered.

This predictive model 71 is the one described above.

The predictive model 71 considers the portion of the power program corresponding to the time interval covered by the injection sequence.

The, at least one, magnitude characteristic of the state of the core calculated by the predictive model 71 depends, among other things, on the chosen cost function. Typically, it comprises at least the parameter R characterizing the neutron flux distribution in the core, in other words, the axial offset AO.

The magnitude characteristics of the state of the core calculated by the predictive model 71 are those described above for the control method.

The cost function calculated by module 73 characterizes, for example, an evolution of a deviation between said parameter R characterizing the neutron flux distribution in the core and a reference value over the given time interval.

The cost function is typically as described above for the control method. Other cost functions can be considered, as described below.

To calculate the cost function, module 73 uses the evolution calculated by the predictive model 71.

The optimization algorithm 75 is programmed to iteratively generate an injection sequence, to calculate the evolution of the at least one corresponding magnitude characteristic by the predictive model 71 of the core and evaluate the corresponding cost function by the cost module 73, until a cost function convergence criterion is met.

The convergence criterion comprises, for example, reaching the extremum of the cost function.

In the case of the cost function examples described above, this extremum is a minimum.

In addition, the convergence criterion may provide that one or more of the following constraints are met:
the deviation between the parameter R characterizing the neutron flux distribution in the core and the reference value during said given time interval remains constantly below a determined limit;
a quantity of neutron poison injected per unit of time during said given time interval remains below a determined limit;
a quantity of water injected per unit of time during said given time interval remains below a determined limit.

The convergence criterion, in particular the constraints, are as described above for the control method.

Preferably, the calculation unit 69 also includes a slope module 77 programmed to determine an optimum slope for the evolution of the reactor power as a function of time during the power variation from the first power to the second power.

The slope module 77 is programmed to:
calculate using the predictive model 71 of the core the evolution of at least one magnitude characteristic of the state of the core of the nuclear reactor during said power variation, for several slope values, the neutron poison or water injection per unit time being considered constantly equal to the maximum possible;
evaluate using the cost module 73 the cost functions corresponding to each slope value, using the evolution calculated for each slope value;
select the slope value which minimizes the cost function.

The slope selected by the predictive model 71 to determine the optimum injection sequence is the optimum slope, possibly minus a safety coefficient. It is also recommended to the operator.

It is calculated only once for a given power program. However, it is recalculated each time the power program changes.

When the power program includes several power variations, an optimum slope value is calculated for each power variation.

This optimum slope is the fastest slope that can be obtained given the existing constraints on the reactor.

Alternatively, the calculation unit 69, does not include the slope module 77. The slope to be used by the predictive model 71 is then set by the operator and entered using the user interface 65.

The slope module 77 preferably determines the optimum slope as described for the control method.

The assembly 63 is also configured to display:
the optimum neutron poison and/or water injection sequence, in other words, that for which the convergence criterion of the cost function has been met;
possibly, the slope selected for the or each power variation;
possibly, the evolution of at least one magnitude characteristic of the state of the core for the optimum injection sequence.

This information is typically displayed on the user interface 65.

FIG. 4 illustrates an example of the screen of the user interface 65 at time instant t0. The upper part of the screen indicates the injection setpoints. The injection setpoints situated above the horizontal line are neutron poison injection setpoints, those below the horizontal line are water injection setpoints.

The lower part of FIG. 4 illustrates the evolution of one of the characteristic state of the core parameters, as a function of time. One or more parameters can be displayed. As indicated above, this parameter or these parameters are chosen from among the parameter R characterizing the neutron flux distribution in the core, the average temperature of the primary heat transfer fluid Tmoy, the power P of the core, the position of the control units Pbank, the xenon Xe concentration, or the neutron poison concentration in the primary heat transfer fluid Cpn.

FIG. 4 illustrates a situation where a new injection sequence is determined with the control assembly 63 every ten minutes. This sequence comprises six injection operations each lasting ten minutes, thus covering a time interval of one hour.

Between t0+10 min and t0+70 min, the upper part of the screen shows the optimum injection sequence calculated using the operating parameters acquired at t0. The lower part of the screen shows the evolution of parameters characteristic of the state of the core calculated for the optimum injection sequence. Between t0 and t0+10 min, the figure shows the injection calculated at the previous iteration, in other words, calculated on the basis of the operating parameters acquired at t0-10 min. FIG. 4 shows the injection actually carried out by the operator between t0-10 min and t0, and the evolution of the parameter characterizing the state of the core actually measured, using the instrumentation 55.

Thus, step S10 of the control method is carried out manually by the operator, who enters the power program on the user interface 65.

The step S20 is carried out by the acquisition unit 67.

The step S30 is carried out by the calculation unit 69.

The sub-step S31 is carried out by the optimization algorithm 75.

The sub-step S32 is carried out by the predictive model 71 of the core.

The sub-step S33 is carried out by the cost function 73.

The sub-step S34 is carried out by the optimization algorithm 75.

The sub-step S35 is carried out by the slope module 77.

The step S40 is typically carried out on the user interface 65.

In the embodiment shown in FIG. 1, the control assembly 63 provides the operator with the optimum neutron poison and/or water injection sequence determined for the time interval considered, together with the slope selected for the power variation.

The operator controls units 31 and 39 directly, as a function of the optimum injection sequence supplied by assembly 63.

Typically, the operator controls valves 37 and 47, and pumps 35 and 45.

In addition, the operator informs the turbine control loop 61 of the selected slope, if any, determined by assembly 63.

According to one alternative embodiment, the cost function is different from that described above.

According to yet another alternative, the predictive model of the core does not take into account a dead zone around the reference temperature Tref. Thus, a displacement in the groups of control rods is determined as soon as Tmoy deviates from Tref.

What is claimed is:

1-16. (canceled)

17: A method for controlling a nuclear reactor, the nuclear reactor having a core comprising a plurality of nuclear fuel assemblies, a primary circuit for cooling the core in which a primary heat transfer fluid containing a neutron poison circulates, a unit allowing neutron poison to be injected into the primary heat transfer fluid, and a unit provided for injecting water into the primary circuit, the method comprising the following steps:
S10/ acquiring a reactor power program to be supplied by the nuclear reactor, this program comprising at least one reactor power variation from a first power to a second power;
S20/ acquiring current values of a plurality of operating parameters of the nuclear reactor, comprising at least one parameter characterizing a core power supplied by the core of the reactor and one parameter characterizing a neutron flux distribution in the core;
S30/ iteratively, implementing the following sub-steps:
S31/ generating an injection sequence of neutron poison and/or water into the primary heat transfer fluid covering a given time interval,
S32/ calculating an evolution of at least one magnitude characteristic of a state of the core of the nuclear reactor during said given time interval using the acquired reactor power program, the acquired current values of the operating parameters and the generated injection sequence, the evolution being calculated with the aid of a predictive model of the core of the reactor;
S33/ evaluating a cost function, using the calculated evolution;
sub-steps S31/ to S33/ being repeated until a cost function convergence criterion is met;
S40/ communicating to an operator an optimum injection sequence allowing the cost function convergence criterion to be met, the operator controlling the neutron poison and water injection units as a function of the optimum injection sequence;
steps S20/ and S30 being repeated with a time period less than 60 minutes.

18: The control method according to claim 17, wherein the at least one magnitude characteristic of the state of the core calculated in step S30/ comprises said parameter characterizing the neutron flux distribution in the core.

19: The control method according to claim 18, wherein the cost function characterizes an evolution of a deviation between said parameter characterizing the neutron flux distribution in the core and a reference value over said given time interval.

20: The control method according to claim 17, wherein the cost function convergence criterion comprises reaching an extremum of the cost function.

21: The control method according to claim 17, wherein the cost function convergence criterion comprises meeting at least one constraint selected from the following list:
a deviation between said parameter characterizing the neutron flux distribution in the core and a reference value during said given time interval remains constantly below a determined limit;
a quantity of neutron poison injected per unit of time during said given time interval remains below a determined limit;
a quantity of water injected per unit of time during said given time interval remains below a determined limit.

22: The control method according to claim 17, wherein in sub-step S31/ the neutron poison and/or water injection sequence into the primary liquid is generated considering results obtained in the previous iteration, by a gradient descent algorithm.

23: The control method according to claim 17, wherein step S30/ comprises a sub-step S35/ for determining an optimum slope for an evolution of the power as a function of time during the power evolution from the first power to the second power, sub-step S35/ comprising the following operations:
S351/ calculating an evolution of the at least one magnitude characteristic of the state of the core of the nuclear reactor during said power variation with the aid of the predictive model of the core of the reactor, for several values of slope, the injection of neutron poison or water per unit of time being considered constantly equal to the maximum possible;
S352/ evaluating the cost function, using the variation calculated for each slope value;
S353/ selecting the slope value minimizing the cost function.

24: The control method according to claim 17, wherein the predictive model of the core of the reactor is non-linear.

25: The control method according to claim 24, wherein the predictive model of the core of the reactor comprises several sub-models, each sub-model modeling a level of the core of the nuclear reactor and comprising at least one equation describing a kinetic of a neutron density at said level and an equation describing a temperature of the primary heat transfer fluid at said level, the model further comprising equations describing neutron exchanges between the levels and equations characterizing a reactivity at each level.

26: The control method as claimed in claim 25, wherein the equations characterizing reactivity at each level take into account one or more of the following effects:
effect due to a variation in the temperature of the primary heat transfer fluid at said level;
effect due to a variation in the power supplied by the core at said level;
effect due to displacement of groups of control rods;
effect due to a variation in a concentration of neutron poison in the primary heat transfer fluid; and
effect due to a variation in a concentration of xenon in the nuclear fuel assemblies at said level.

27: The control method according to claim 17, wherein the sequence of injection of neutron poison and/or water into the primary liquid comprises a plurality of injection operations, each operation being characterized by an operation quantity and duration, a number of operations in the injection sequence being between 2 and 12, the duration of the operation being between 2 minutes and 60 minutes.

28: The control method according to claim 27 wherein the time period is less than or substantially equal to the duration of one operation in the injection sequence.

29: The control method according to claim 17, wherein the given time interval has a total duration of between 10 minutes and a duration of the reactor power program.

30: A control assembly for a nuclear reactor, the nuclear reactor having a core comprising a plurality of nuclear fuel assemblies, a primary circuit for cooling the core, in which a primary heat transfer fluid containing a neutron poison circulates, a unit allowing the neutron poison to be injected into the primary heat transfer fluid, and a unit provided for injecting water into the primary circuit, the neutron poison and water injection units being controlled by an operator, the control assembly comprising:
a user interface, configured so that a user enters a power program to be supplied by the nuclear reactor, this program comprising at least one power variation from a first power to a second power;
a unit for acquiring current values of a plurality of operating parameters of the nuclear reactor, comprising at least one parameter characterizing the power supplied by the core of the reactor and one parameter characterizing a neutron flux distribution in the core; and
a calculation unit including:
an optimization algorithm, programmed to generate an injection sequence of neutron poison and/or water in the primary heat transfer fluid covering a given time interval;
a predictive model of the core of the reactor, programmed to calculate an evolution of at least one magnitude characteristic of a state of the core of the nuclear reactor during said given time interval, using the acquired reactor power program, the acquired current values of the operating parameters and the generated injection sequence; and
a cost module configured to calculate a cost function, using the evolution calculated by the predictive model;
the optimization algorithm being programmed to iteratively generate an optimum injection sequence, to calculate the evolution of the at least one corresponding magnitude characteristic by the predictive model of the core, to evaluate the corresponding cost function by the cost module, until a cost function convergence criterion is met; and
the control assembly also being configured to display the optimum injection sequence, in other words, that for which the cost function convergence criterion has been met, on the user interface, so that the optimum injection sequence is implemented by the operator.

31: The control assembly according to claim 30, wherein the calculation unit comprises a slope module programmed to determine an optimum slope for an evolution of reactor power as a function of time during the power variation from the first power to the second power, said slope module being programmed to:
cause the predictive model of the core calculate the evolution of at least one magnitude characteristic of the state of the core of the nuclear reactor during said power variation, for several slope values, the neutron poison or water injection per unit time being considered constantly equal to the maximum possible;
cause the cost module evaluate the cost functions corresponding to each slope value, using the evolution calculated for each slope value; and
select the slope value that minimizes the cost function.

32: A nuclear reactor including a core comprising:
a plurality of nuclear fuel assemblies;
a primary circuit for cooling the core in which a primary heat transfer fluid containing a neutron poison circulates;
a unit allowing neutron poison to be injected into the primary heat transfer fluid;
a unit provided for injecting water into the primary circuit; and
the control assembly according to claim 30, the neutron poison and water injection units being controlled by an operator.
